(19) United States
(12) Patent Application Publication
(10) Pub. No.: US 2010/0238190 A1
(43) Pub. Date: Sep. 23, 2010

(54) JOINT HIGH DYNAMIC RANGE COMPRESSION AND NOISE REDUCTION

(76) Inventors: Florian Ciurea, San Jose, CA (US); Alexander Berestov, San Jose, CA (US)

Correspondence Address: JOHN P. O'BANION;O'BANION & RITCHEY LLP, 400 CAPITOL MALL SUITE 1550, SACRAMENTO, CA, 95814, US

(21) Appl. No.: 12/405,490

(22) Filed: Mar. 17, 2009

(51) Int. Cl. G09G 5/02; G06K 9/36

(52) U.S. Cl. 345/589; 382/166

(57) ABSTRACT

A high dynamic range (HDR) compression method and apparatus modeled after the heat equation describing temperature changes in a thin plate. This approach allows combining high dynamic range compression together with noise reduction in a single process, to be performed within the same iteration of the heat equation. Noise reduction is of particular concern while performing HDR compression because brightening of dark areas during high dynamic range compression has the potential to increase noise levels. Performing image processing techniques in combination according to the invention provides enhanced results while lowering the overall processing overhead. This innovation extends the heat equation analogy by adding anisotropic diffusion as an additional term, which allows joint operation of HDR and NR and mitigates noise enhancement within HDR compression during shadow enhancement.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention

This invention pertains generally to image processing, and more particularly to high dynamic range image compression.

2. Description of Related Art

Image processing is important in today's highly visual environment, with still and video images being viewed from commercial broadcasts, satellites, cable, pod casts, internet and on stored media, to name just a few. Digital image capture devices are becoming ubiquitous with cameras on most all cell phones.

Often the images which are captured or otherwise directed for display have a dynamic range which extends beyond the capabilities of the target medium, device or format. Dynamic range of an image is the ratio of the brightest intensity level to the darkest intensity level which can be presented on a given medium, device or format. For example, camera film is capable of capturing a higher range of intensity than can be reproduced in print or on traditional displays. Advanced sensor technologies have led to devices with higher dynamic range which may extend beyond the capability of the intended display.

The process of dynamic range compression refers to a method of reducing the dynamic range of an image, for example to make it more appropriate for a given output device. One major objective in performing high dynamic range compression is to balance the bright and dark areas of the image toward improving the contrast and maintaining the detail of the original image.

Accordingly, a need exists for a system and method of image processing which can perform high dynamic range compression without increasing noise or introducing artifacts. These needs and others are met within the present invention, which overcomes the deficiencies of previously developed image processing system and methods.

### BRIEF SUMMARY OF THE INVENTION

The present invention is a high dynamic range compression method and apparatus that is modeled after the “heat equation” within which high dynamic range compression can be combined with a noise reduction process. Noise reduction is of particular concern with regard to high dynamic range compression because brightening of dark areas during high dynamic range compression has the potential to increase noise levels and introduce artifacts. The current method teaches performing simultaneous high dynamic range compression and noise reduction in a single process. Applications of the present invention include all forms of image processing, such as in cameras and other still and video image capture devices.

The present invention may be applied in different ways and to different components in different color spaces. In addition, one of ordinary skill in the art will appreciate that modifications on the use of the heat equation can be applied without departing from the teachings of the present invention. For example, the heat equation can be utilized with different terms applied to different color channels at different points within the signal processing pipeline. For example, in digital cameras the signal is usually transferred from RGB to YCC, wherein an implementation of the present invention can be applied twice—once after RGB signal acquisition, and a second time after conversion to YCC. It can also be applied not only to Y but to Cb, Cr in order to compensate for potential color shift and to reduce the chrominance noise. Furthermore, additional terms can be added to the heat equation without departing from the teachings of the present invention, thereby potentially addressing extra problems or as an aid in solving joint high-dynamic range (HDR) and noise reduction (NR) problem. One example discussed herein adds another term with a different diffusion coefficient to aid improved calculation accuracy for the heat source.

The invention is amenable to being embodied in a number of ways, including but not limited to the following descriptions.

One embodiment of the invention is an apparatus for rendering high dynamic range (HDR) images on low dynamic range (LDR) displays, comprising: (a) a computer processor configured for receiving an image input; (b) memory coupled to the computer processor; (c) programming, retained in memory, executable on said computer processor for: (c)(i) representing HDR image pixel intensity as a function of several independent variables, (c)(ii) describing the changes of image pixel intensity with a partial differential equation (PDE) that involves (performed in response to) the function and its partial derivatives with respect to the independent variables, and (c)(iii) obtaining LDR image pixel intensity as a solution of the partial differential equation (PDE).

One embodiment of the invention is a method of performing high dynamic range (HDR) compression on an image input, comprising: (a) determining an external heat source term; (b) performing HDR compression within a partial differential of a heat equation; and (c) performing iterations of the above partial differential through space and time to arrive at an image output.

In one preferred aspect of the invention noise reduction (NR) is additionally performed in combination with said high dynamic range (HDR) compression, by (i) determining a diffusion coefficient before an iteration of the heat equation; and (ii) adding a diffusion term to the heat equation, or processing NR separately within the same iteration.

It should be appreciated that the heat equation comprise a mechanism through which the foundational HDR compression and NR processing is combined. In this way the heat equation is used to model components of image color space as a thermal distribution on a thin plate. Utilization of the method increases computational efficiency over performing the HDR compression and NR methods separately, since the compression and noise reduction are performed during the same iteration pass, while reducing resultant noise levels. The method can be utilized in any desired color space, or portion thereof. In addition, one color space can be transformed to another color space prior to performing the inventive method. By way of example and not limitation, the image input can be received in a color format, such as, but not limited to, RGB, YCC, XYZ, La*b*, HLS, grayscale, and so forth.

One embodiment of the invention is a method of performing high dynamic range (HDR) compression and noise reduction (NR) on an image input, comprising: (a) receiving a first image signal; (b) separating any portions of the color space which are not being processed; (c) determining external heat source and diffusion coefficient; (d) establishing boundary conditions for the heat equation; (e) performing integration of the heat equation on a finite difference grid; (f) executing additional iterations of steps (c) though (e) until a desired stop condition is reached; and (g) combining any separated portions of the color space to generate an image output.

One embodiment of the invention is an apparatus for performing high dynamic range (HDR) compression and noise reduction (NR) on an image input, comprising: (a) a computer processor configured for receiving an image input; (b) programming, retained in memory, executable on said computer processor for, (b)(i) determining an external heat source and diffusion coefficient, (b)(ii) performing HDR compression and NR within the same iteration of partial differential for a heat equation, and (b)(iii) performing iterations of the above through space and time to arrive at an image output.

One embodiment of the invention is a computer-readable media containing a computer program executable on a computer configured for high dynamic range (HDR) compression and noise reduction (NR) in response to steps, comprising: (a) determining an external heat source and diffusion coefficient; (b) performing HDR compression and NR within the same iteration of partial differential for a heat equation; and (c) performing iterations of the above through space and time to arrive at an image output.

The present invention provides a number of beneficial aspects which can be implemented either separately or in any desired combination without departing from the present teachings.

An aspect of the invention is an efficient method of performing HDR compression utilizing the heat equation.

Another aspect of the invention is a method for combining the computation of HDR compression and NR within each iteration pass of solving the partial differential equations (PDEs).

Another aspect of the invention is to process the image signals with lowered noise and high computational efficiency when combining the HDR compression and NR.

Another aspect of the invention is a method of performing compression and noise reduction which can be applied to various color spaces, or portions thereof.

Another aspect of the invention is a method of performing compression and noise reduction in the same equation, or separated in various ways within the same iteration pass of solving the PDEs.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a flowchart for high dynamic range compression and noise reduction using the heat equation according to an embodiment of the present invention, showing HDR and NR computed together.

FIG. 2 is a flowchart for high dynamic range compression and noise reduction using the heat equation according to an embodiment of the present invention, showing that HDR and NR computed separately in the same iteration pass.

FIG. 3 is a flowchart showing separate processing of each color component within a color space according to an aspect of the present invention.

FIG. 4 is a flowchart for high dynamic range compression and noise reduction using the heat equation according to an embodiment of the present invention, showing one color component in the color space being processed.

FIG. 5 is a flowchart for high dynamic range compression and noise reduction using the heat equation according to an embodiment of the present invention, showing heat equation integration split into multiple fractional iterative steps.

FIG. 6A-6B are camera images comparing PDE HDR in YCC space applied to the HDR image according to an aspect of the present invention, with current best practices HDR compression.

FIG. 7A-7C are camera images comparing an original image, image subject to isotropic diffusion, and image subject to anisotropic diffusion according to aspects of the present invention.

FIG. 8 is a diagram indicating finite difference grid according to an aspect of the present invention.

FIG. 9A-9B are camera images comparing current best practices HDR compression, with Anisotropic Diffusion Noise Reduction (ADNR) applied to current best practices HDR compression.

FIG. 10A-10B are camera images comparing joint HDR and ADNR with PDE according to an aspect of the present invention, with ADNR applied to current best practices HDR compression.

FIG. 11 is a block diagram of a camera or image processing apparatus configured for performing high dynamic range compression according to an embodiment of the present invention, showing a computer and memory upon which programming executes one or more methods of the invention.

### DETAILED DESCRIPTION OF THE INVENTION

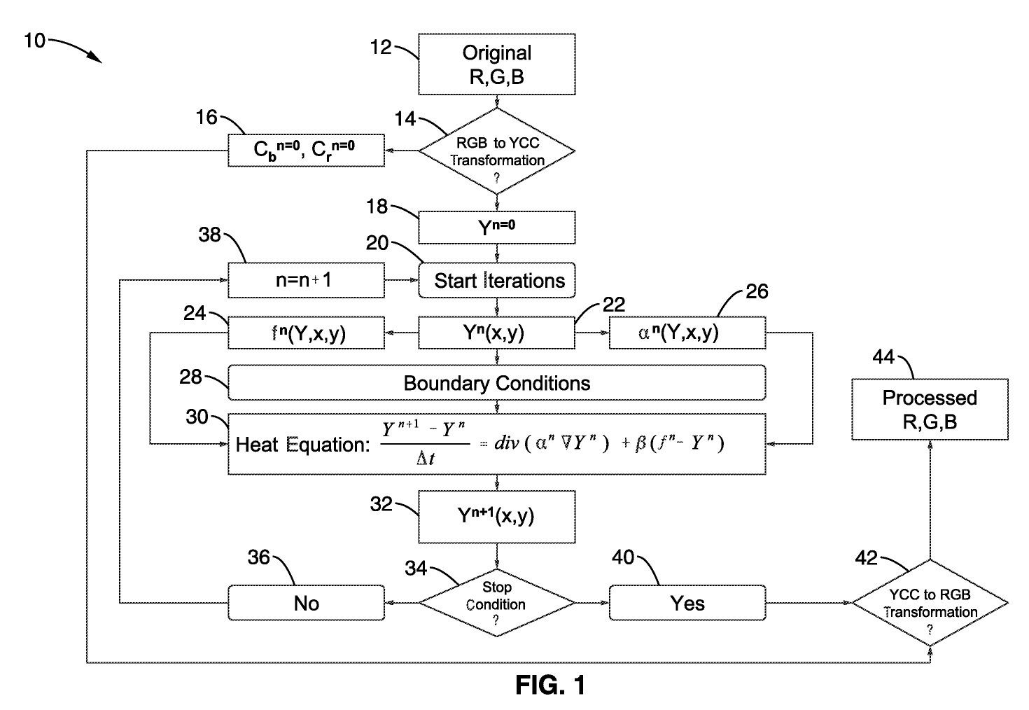

Referring more specifically to the drawings, for illustrative purposes the present invention is embodied in the apparatus generally shown in FIG. 1 through FIG. 11. It will be appreciated that the apparatus may vary as to configuration and as to details of the parts, and that the method may vary as to the specific steps and sequence, without departing from the basic concepts as disclosed herein.

### 1. INTRODUCTION

The method and apparatus of the invention simultaneously performs high dynamic range compression and noise reduction on an imaging input. It will be appreciated that noise considerations are very important when performing high dynamic range compression, as brightening of dark areas during the high dynamic range compression process often leads to increased levels of noise. Performing the simultaneous noise reduction coupled with high dynamic range compression provides unexpectedly benefits with regard to noise reduction in comparison with performing the techniques separately.

Modeling the high dynamic range (HDR) compression method as a partial differential equation provides the framework for combining this process with other important image processing operations. In particular, combining high dynamic range compression with noise reduction can be both more effective in noise suppression and more computationally efficient than performing two separate methods, as the two operations are essentially performed during the same iteration pass.

The present invention teaches both global and local frameworks for joint high dynamic range compression and noise reduction. For the noise reduction component, anisotropic diffusion is preferably utilized as proposed by Perona and Malik, although other noise reduction techniques (e.g., isotropic diffusion) that can be formulated as a partial differential equation may be alternatively utilized.

This method of HDR compression is based on the similarity with heating mechanisms in physics, and utilizes the partial differential equation for heat transfer in the general form of:

∂T/∂t=b(ƒ(x,y,t,T)−T)+(∂/∂x)(a∂/∂xt)+(∂/∂y)(a∂/∂yT) (1)

The technique considers image intensity in a manner similar to the temperature of a thin plate. Function ƒ represents external heat sources that change the temperature of the plate through thermal conductivity, wherein the conductivity coefficient can also be spatially and temporally variable. This innovation extends the heat equation analogy by adding anisotropic diffusion as an additional term. Simultaneous consideration of external heat exchange and internal diffusion allows joint operation of HDR and NR on images which provide improved control over noise in dark areas. The present invention provides a unique approach to solve one of the main problems of HDR compression, specifically noise enhancement (increasing noise) during shadow enhancement. It will be recognized that the present invention can be applied to still images (e.g., photos), or sequences of images (e.g., video).

### 2. EXAMPLE EMBODIMENTS

FIG. 1 is an example embodiment 10 of joint high dynamic range (HDR) compression and noise reduction (NR). An original image signal is acquired as represented by block 12, and may be provided by any desired source, such as from a sensor, a file, or acquired by alternative means. The image signal can be configured in any color format (e.g., RGB, YCC, XYZ, La*b*, HLS, etc.) or can be grayscale (no color component). By way of example FIG. 1 illustrates the original signal being received in an RGB color format and transformed in block 14 to a YCC color space. Initial color components C_{b}ⁿ⁼⁰, Cᵣⁿ⁼⁰ are separated as shown in block 16 and only an initial Yⁿ⁼⁰ component is further processed as per block 18.

An iteration sequence is entered 20 in which value n is the iteration number. It should be recognized that each successive iteration represents a new incremental time. Accordingly, HDR image pixel intensities are integrated over time until the resulting intensities become low dynamic range (LDR). Upon entering the start of iteration sequence 20, the initial luminance component Yⁿ⁼⁰ is processed in block 22 to determine initial heat source, or alternatively referred to as an external intensity source, ƒⁿ⁼⁰ as per block 24 and diffusion coefficient αⁿ⁼⁰ as per block 26. It should be appreciated that according to one implementation, the diffusion coefficient can be set to a constant, wherein isotropic diffusion would be considered. In the current embodiment shown in FIG. 1 parameter β is set to be constant, however, in similar manner to ƒ(x,y) it can depend on location and can be set at this step.

In block 28 boundary conditions are set for the heat equation. By way of example and not limitation, these boundary conditions can be set by Neumann boundary conditions (see Eqs. 20-23, described in a later section), or alternative boundary conditions required to solve the heat equation. By way of another example, Dirichlet boundary conditions can be utilized when Y takes prescribed values on the boundary of the region.

As per block 30 the heat equation is shown integrated on a finite difference grid for one time step Δt, and duplicated below in Eq. 2.

$$\frac{{Y}^{n + 1} - {Y}^{n}}{Δ t} = div ( {α}^{n} ∇ {Y}^{n} ) + β ( {f}^{n} - {Y}^{n} ) \qquad ( 2 )$$

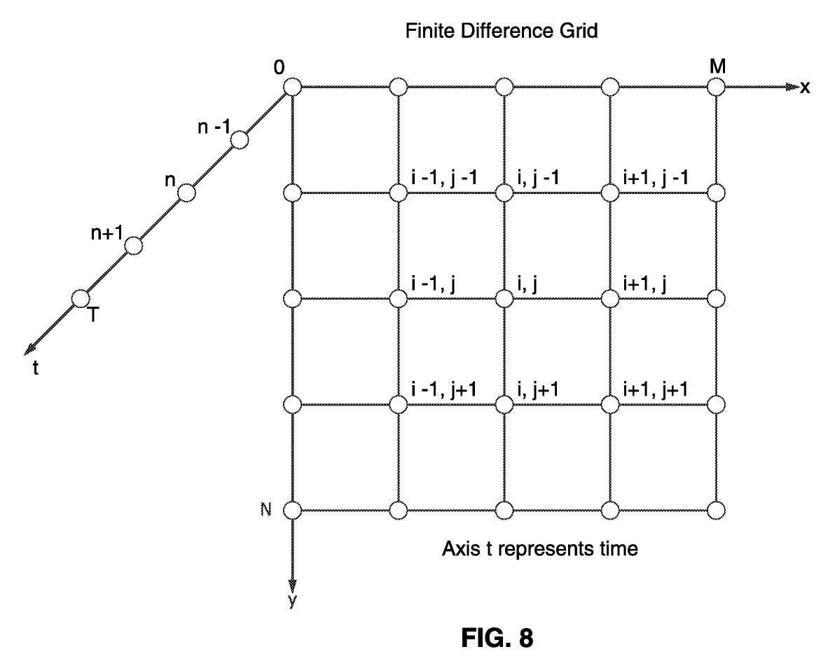

It should be appreciated that the value of Δt may vary from iteration to iteration. The finite difference grid, such as shown in FIG. 8, can also be configured in alternative formats, such as a triangular grid. Finite difference scheme for time integration can be as described in the figure, or alternative time integration schemes may be utilized, for instance implicit integration. A spatial finite difference scheme may be utilized as represented by Eq. 24, described in a later section, or other difference schemes may be utilized. Time step Δt can be constant or can be changed with every iteration.

After integration, a new value of the luminance component Yⁿ⁼¹ is obtained in block 32 and a stop condition is checked as per block 34. The stop condition can estimate the new dynamic range of the scene or can perform other forms of evaluation of the luminance component Yⁿ⁼¹, such as a comparison with Yⁿ⁼⁰. It should be appreciated that the luminance ratio is a ratio between the brightest and the darkest parts of the scene. It should be recognized that the HDR image pixel intensity is being integrated over time until the resulting intensities become LDR. By definition, dynamic range of the image is the luminance ratio between the brightest and the darkest parts of the scene, and the stop condition can be this ratio. For example HDR scene has 1000:1 ratio, but our display is capable of only 256:1 ratio, so we stop when this ratio is achieved. It should also be appreciated that other stop conditions may be adopted without departing from the teachings of the invention, for example utilizing the number of iterations or the total time of integration.

If stop condition 34 is not met, as represented in block 36, then n is incremented in block 38 (e.g., from Yⁿ⁼⁰ to Yⁿ⁼¹) and the new value considered as a new initial value and for performing another iteration 20. If the stop condition is met as per block 40, initial color components s C_{b}ⁿ⁼⁰, Cᵣⁿ⁼⁰ are used together with the final value of luminance component in block 42 and a processed RGB value is output as shown in block 44.

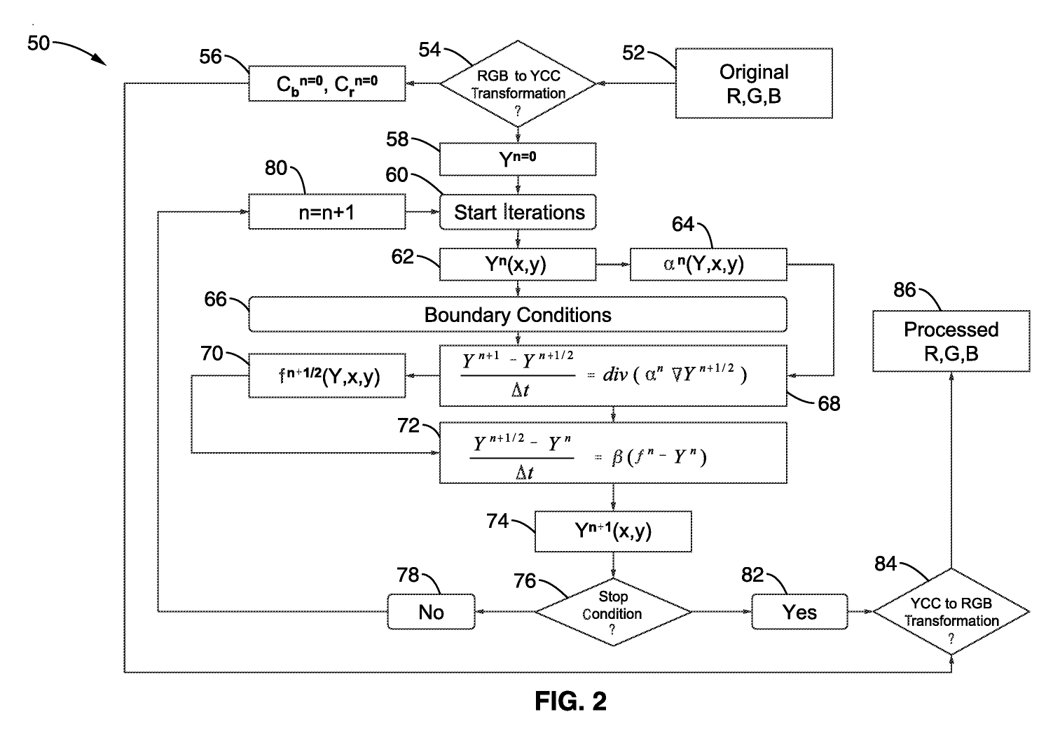

FIG. 2 illustrates another example embodiment of HDR compression and NR in which HDR and NR are computed separately. As described below, the initial steps prior to executing the heat equation are performed similarly to that shown in FIG. 1.

An original image signal is acquired as represented by block 52 and transformed in block 54 to a YCC color space. Initial color components C_{b}ⁿ⁼⁰, Cᵣⁿ⁼⁰ are separated as shown in block 56 and only an initial Yⁿ⁼⁰ component is further processed as per block 58.

Upon entering the start of iteration sequence 60, the initial luminance component Yⁿ⁼⁰ is processed in block 62 to determine only the diffusion coefficient αⁿ⁼⁰ as per block 64. Boundary conditions are set in block 66 for the heat equation.

This embodiment illustrates a case in which the HDR compression term (external heat source) and noise reduction term (anisotropic diffusion term) are not combined into one equation. By way of example, this embodiment solves the two equations consecutively. First the diffusion is performed at n+½ step in block 68, and then after calculating the “heat source” in block 70, the compression step is performed at the n+1 step in block 72, these equations are repeated below as Eqs. 3-5.

$$\begin{matrix}\frac{{Y}^{n + 1} - {Y}^{n + 1 / 2}}{Δ t} = div ( {α}^{n} ∇ {Y}^{n + 1 / 2} ) & ( 3 ) \\ {f}^{n + 1 / 2} ( Y , x , y ) & ( 4 ) \\ \frac{{Y}^{n + 1 / 2} - {Y}^{n}}{Δ t} = β ( {f}^{n} - {Y}^{n} ) & ( 5 )\end{matrix}$$

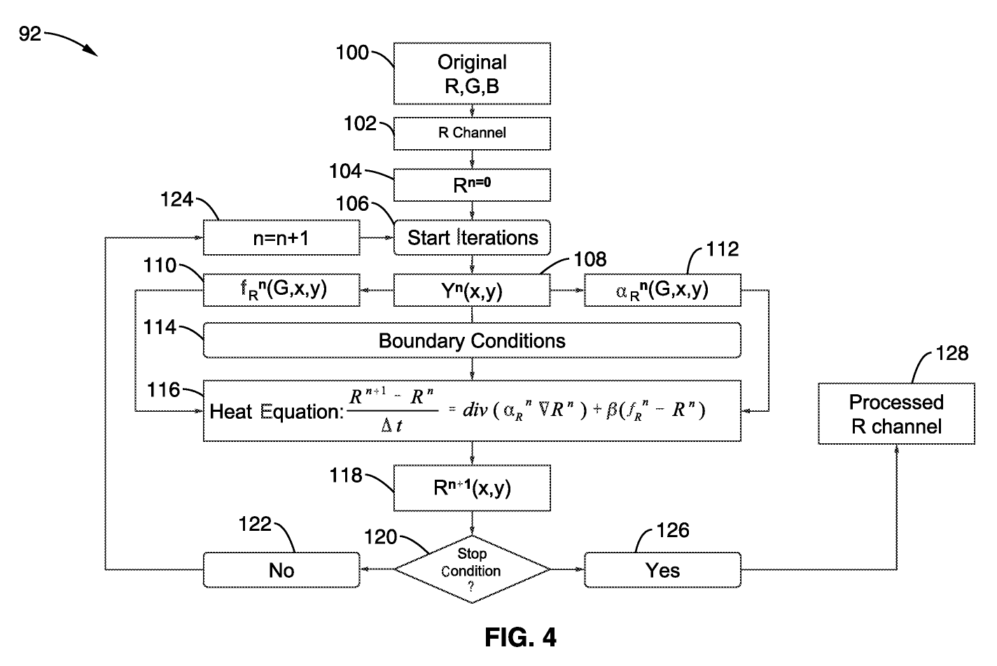

It should, however, be appreciated that the compression can be performed first, followed by the diffusion step. It should also be noted that the external “heat source”, or diffusion coefficient, may be calculated at the intermediate step n+½ (shown in FIG. 4).

A new value of luminance component Yⁿ⁼¹ is obtained in block 74 and stop condition checked in block 76. If the stop condition is not met, as per block 78, then n is incremented in block 80 for performing another iteration 60. If the stop condition is met as per block 82, then initial color components C_{b}ⁿ⁼⁰, Cᵣⁿ⁼⁰ are used together with the final value of luminance component in block 84 and a processed RGB value as shown in block 86.

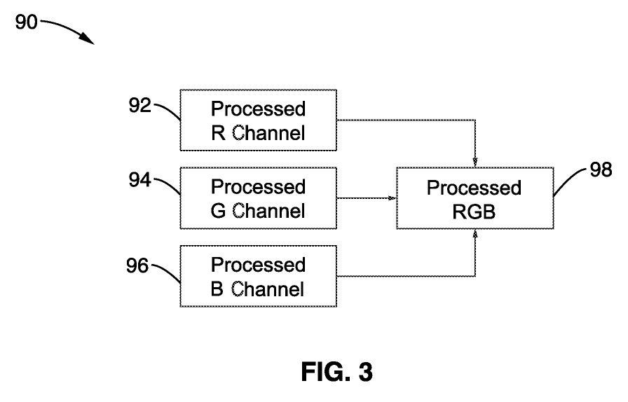

FIG. 3 illustrates a method of performing HDR compression and NR 90 according to the invention, which can be applied to different components in different color spaces separately. By way of example, and not limitation, the RBG color space is considered in which the R (RED) channel is processed 92, and the G (GREEN) channel 94, and the B (BLUE) channel 96, which are combined to provide processing of the entire RGB color space 98. It should be appreciated that this approach can be applied to all the described embodiments, to variations of these embodiments, and to combinations thereof.

FIG. 4 illustrates an example embodiment 92, in which the R (RED) channel is being separately processed, as shown in FIG. 3. The steps follow in line with those depicted and described for FIG. 1, yet directed at the R channel. It should be noted that all of the parameters, such as ƒ, α, β, Δt, and so forth, or finite difference schemes, or finite difference grids, or boundary conditions can be different for different channels. Also parameters used for one component may depend on the other components at different time steps. For example, it will be noted in blocks 110 and 112 that ƒ and α for the R channel depend on the intensity of the G (GREEN) channel.

An original image signal is acquired as represented by block 100, from which the R channel extracted in block 102 with only an initial Rⁿ⁼⁰ component in block 104 being further processed. Upon entering the start of iteration sequence 106, the initial R channel Rⁿ⁼⁰ is processed in block 108 to determine initial external “heat source” ƒ_{R}ⁿ(G,x,y) as per block 110 and diffusion coefficient α_{R}ⁿ(G,x,y) as per block 112. Boundary conditions are set in block 114, and the heat equation is performed in block 116, and shown below in Eq. 6.

$$\frac{{R}^{n + 1} - {R}^{n}}{Δ t} = div ( {{α}_{R}^{n} ( ∇ R )}^{n} ) + β ( {f}_{R}^{n} - {R}^{n} ) \qquad ( 6 )$$

A new value of the R channel component Rⁿ⁺¹(x,y) is obtained in block 118 and a stop condition checked in block 120. If the stop condition is not met, as per block 122, then n is incremented in block 124 for performing another iteration 106. If the stop condition is met as per block 126, then a processed R channel value is output as shown in block 128.

It should be appreciated that the results provided by the present invention can be different in different color spaces. For example, application of external heat source and anisotropic diffusion to saturation and hue channels in HLS color space will change colors and filter chrominance noise. Accordingly, the present invention can be utilized for white balance applications or for color adjustments.

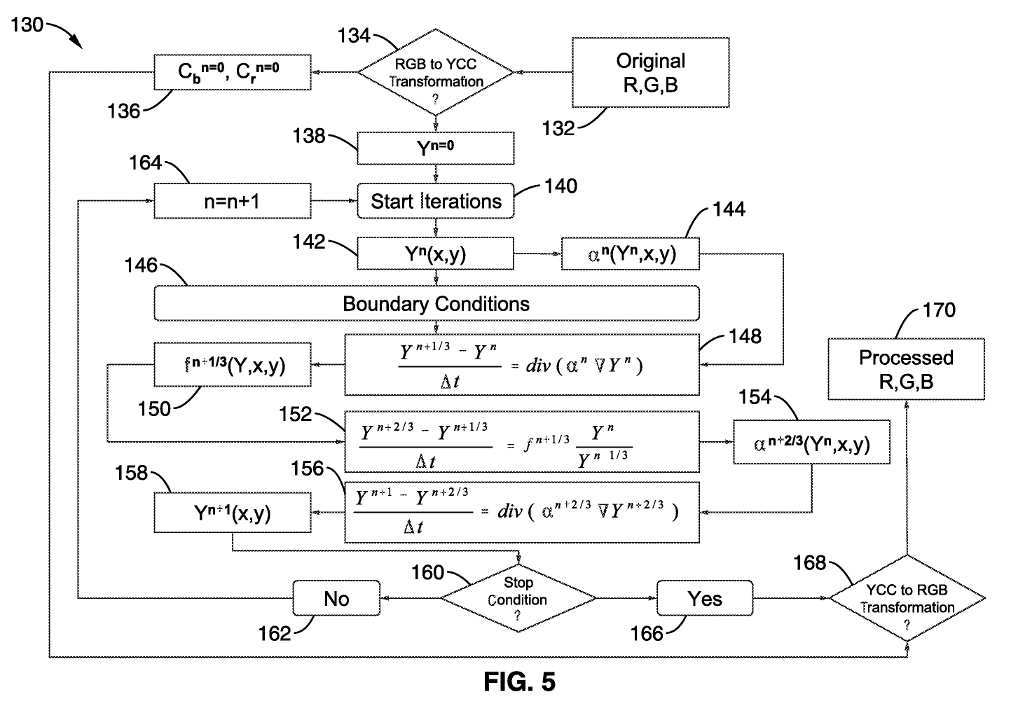

FIG. 5 illustrates another example embodiment 130 of HDR compression and NR which provides improved preservation of details within the same heat equation framework as detailed in FIG. 1.

An original image signal is acquired as represented by block 132 and transformed in block 134 to a YCC color space. Initial color components C_{b}ⁿ⁼⁰, Cᵣⁿ⁼⁰ are separated as shown in block 136 and only an initial Yⁿ⁼⁰ component is further processed as per block 138.

Upon entering the start of iteration sequence 140, the initial luminance component Yⁿ⁼⁰ is processed in block 142 to determine only the diffusion coefficient αⁿ⁼⁰ as per block 144. Boundary conditions are set in block 146 for the heat equation.

In this implementation example, the heat equation is performed with the integration portion split into thirds. The first ⅓ step, as represented in block 148, anisotropic diffusion αⁿ(Yⁿ,x,y) is used to obtain the smoothed version of the luminance intensity with sharp edges. Then external heat source is calculated using this intermediate intensity: ƒ=ƒ^{n+1/3}(Y,x,y), as per block 150.

During the second ⅓ of the integration step this external heat source is used to compress the dynamic range. In this particular case compression depends not on the difference between the luminance intensity and external heat source (as in FIGS. 1, 2 and 4), but on the product of the heat source and the ratio of the original intensity and smoothed intensity, as shown in block 152.

This new compressed luminance intensity is used to obtain a new anisotropic diffusion coefficient in block 154 α=α(Y^{n+2/3},x,y), which is used in the third step of block 156 to perform noise reduction. It should be appreciated that αⁿ(Yⁿ,x,y) and α=α(Y^{n+2/3}, x,y) are different and can be obtained using different operations. The equations from steps 148-156 of FIG. 5 are duplicated below in Eqs. 7-11.

$$\begin{matrix}\frac{{Y}^{n + 1 / 3} - {Y}^{n}}{Δ t} = div ( {α}^{n} ∇ {Y}^{n} ) & ( 7 ) \\ {f}^{n + 1 / 3} ( Y , x , y ) & ( 8 ) \\ \frac{{Y}^{n + 2 / 3} - {Y}^{n + 1 / 3}}{Δ t} = {f}^{n + 1 / 3} \frac{{Y}^{n}}{{Y}^{n + 1 / 3}} & ( 9 ) \\ {α}^{n + 1 / 3} ( {Y}^{n} , x , y ) & ( 10 ) \\ \frac{{Y}^{n + 1} - {Y}^{n + 2 / 3}}{Δ t} = div ( {α}^{n + 2 / 3} ∇ {Y}^{n + 2 / 3} ) & ( 11 )\end{matrix}$$

After integration, a new value of luminance component Yⁿ⁺¹(x,y) is obtained in block 158 and a stop condition is checked as per block 160. If stop condition is not met as per block 162 then n is incremented in block 164 prior to commencing another iteration 140. If the stop condition is met as per block 166, then the initial color components s C_{b}ⁿ⁼⁰, Cᵣⁿ⁼⁰ are used together with the final value of luminance component in block 168 and a processed RGB value output as per block 170.

### 3. DISCUSSION OF THEORETICAL BASIS AND RESULTS

These PDE models perform image processing as an evolutionary process. The change in image intensity “u” is modeled by transformation T as given by:

$$\frac{\partial u}{\partial t} = T [ u ( x , y , t ) ] \qquad ( 12 )$$

The theoretical basis for the method of the present invention is outlined below, and associated test results are discussed. Utilizing PDEs is a mechanism through which the foundational algorithms can be combined. For example, consider two image processing transformations T₁ and T₂. Wherein the PDE formulation for transformation T₁ is given by:

$$\frac{\partial u}{\partial t} = {T}_{1} [ u ( x , y , t ) ] \qquad ( 13 )$$

While the PDE formulation for transformation T₂ is given by:

$$\frac{\partial u}{\partial t} = {T}_{2} [ u ( x , y , t ) ] \qquad ( 14 )$$

The PDE formulation for the combination transformations of T₁ and T₂ is then provided by:

$$\frac{\partial u}{\partial t} = α \cdot {T}_{1} [ u ( x , y , t ) ] + {T}_{2} [ u ( x , y , t ) ] \qquad ( 15 )$$

The technique provides partial results at each intermediate step, from the original image, through step 1, step 2, to step n−1 and finally to step n which produces the final image.

In one aspect of the invention, high dynamic range (HDR) compression is described using PDE techniques applied to the luminance component u. The following Eqs. 16-17 are directed to transformation T₁:

$$\begin{matrix}\frac{\partial u}{\partial t} = β ( f - u ) , f = {8.29 [ ln ( u + 1 ) ]}^{2} , β = const & ( 16 ) \\ ( \begin{matrix}\begin{matrix}u \\ R - u\end{matrix} \\ B - u\end{matrix} ) = ( \begin{matrix}0.299 & 0.587 & 0.114 \\ 0.701 & - 0.587 & - 0.114 \\ - 0.299 & - 0.587 & 0.886\end{matrix} ) ( \begin{matrix}\begin{matrix}R \\ G\end{matrix} \\ B\end{matrix} ) & ( 17 )\end{matrix}$$

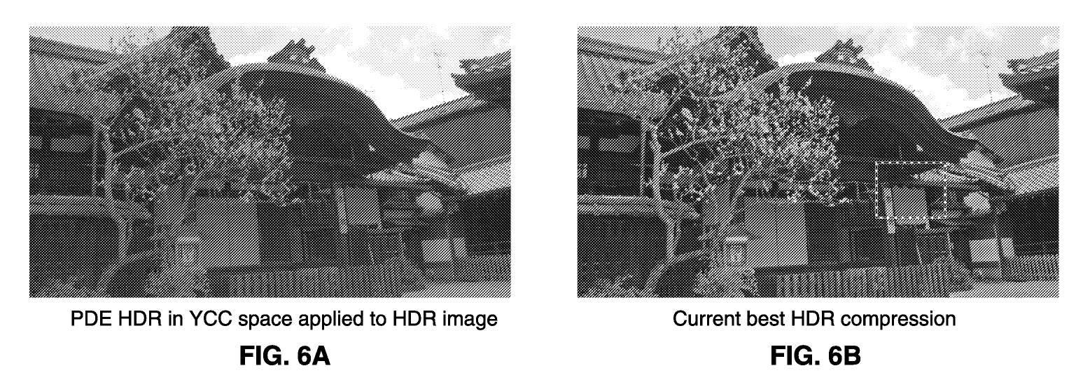

FIG. 6A illustrates a PDE HDR in a luminance-chrominance space, such as (YCC), which is an image color space used for photo CDs and is similar in kind to the LAB color space. The YCC format has been used for some time by video design engineers and within televisions, JPG formatted images, and color video devices. YCC transmits or represents the three Red, Green and Blue (RGB) channels as a luminance channel (Y) and two color-difference channels, Cr and Cb (CC).

FIG. 6B illustrates the image using what is considered current best practices HDR compression techniques. High dynamic range (HDR) compression refers to a dynamic range reduction mechanism for an image toward making it more appropriate for display on a given output device. One principle objective of HDR compression is the balancing of bright and dark areas of the image so as to improve the contrast and maintain the detail of the original image. Current best practices for HDR compression include use of a modified cumulative histogram as a compression curve. This curve is computed from the cumulative histogram of the image with constraints that the local derivative on the curve does not exceed a certain limit. The limit is fixed along the curve or the limit is variable, taking into account noise characteristics at various pixel values. To provide appropriate detail preservation, a smoothing filter is used to separate the image into an illumination image, referred to as a base image, and a detail image. The compression curve is applied to the base image only. The compression method provides high dynamic range compression of the image while preserving the global contrast perception. It will be appreciated that conventional algorithms based on global compression tone-mapping functions are not capable of achieving this result. The compression method also minimizes noise amplification while lightening the dark areas during image compression.

A region of interest box is highlighted in FIG. 6B which is examined at higher magnifications in the following image examples.

The following considers isotropic diffusion versus anisotropic diffusion (transformation T₂). The classical technique of isotropic diffusion can be characterized by:

$$\frac{\partial u}{\partial t} = div ( α \cdot ∇ u ) \qquad ( 18 )$$

While anisotropic diffusion of Perona-Malik from 1990, can be characterized by:

$$\frac{\partial u}{\partial t} = div ( α \cdot ( ‖ ∇ u ‖ ) \cdot ∇ u \qquad ( 19 )$$

In the above, the term α now restricts diffusion to areas of reduced gradient, which operates to preserve the edges.

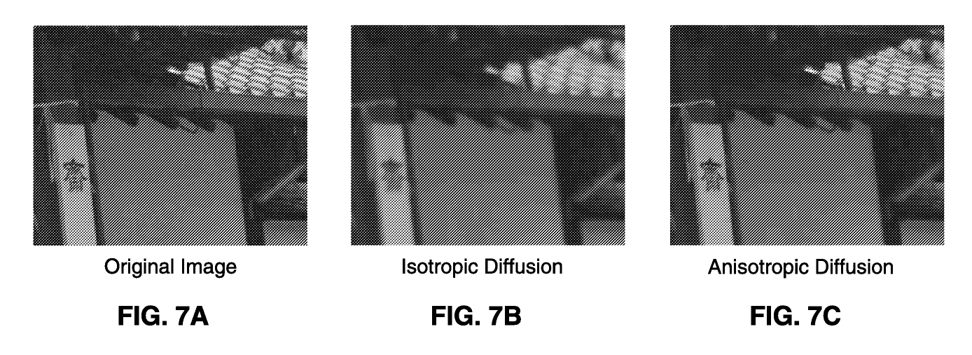

FIG. 7A-7C depict images from the box of interest within FIG. 6B, shown as original image in FIG. 7A, isotropic diffusion in FIG. 7B, and anisotropic diffusion in FIG. 7C. It will be appreciated that the kanji character on the door post is barely legible in response to the isotropic diffusion, but appears as clearly readable in the anisotropic diffusion as within the original image of FIG. 7A.

Basic Equations for Joint HDR & NR with anisotropic diffusion (transformations T₁+T₂) are given as:

$$\begin{matrix}\frac{\partial u}{\partial t} = div ( α \cdot ∇ u ) + β ( f - u ) & ( 20 ) \\ u ( x , y , t ) = {u}_{0} ( x , y ) at t = 0 & ( 21 ) \\ \frac{\partial u}{\partial x} = 0 at x = 0 , x = M & ( 22 ) \\ \frac{\partial u}{\partial y} = 0 at y = 0 , x = N & ( 23 )\end{matrix}$$

The above outlines the heat equations with Neumann boundary conditions.

FIG. 8 illustrates a finite difference grid with the t axis representing time, while i and j values define pixel location in the image, such as i=j=0 corresponding to top-left pixel of the image. The following equation is an explicit finite difference approximation of the equation (20).

$$\begin{matrix}\frac{{u}_{i , j}^{n + 1} - {u}_{i , j}^{n}}{Δ t} = \frac{1}{2} ( ( {α}_{i , j}^{n} + {α}_{i + 1 , j}^{n} ) ( {u}_{i + 1 , j}^{n} - {u}_{i , j}^{n} ) ) - \\ ( ( {α}_{i - 1 , j}^{n} + {α}_{i , j}^{n} ) ( {u}_{i , j}^{n} - {u}_{i - 1 , j}^{n} ) ) + \\ ( ( {α}_{i , j}^{n} + {α}_{i , j + 1}^{n} ) ( {u}_{i , j + 1}^{n} - {u}_{i , j}^{n} ) ) - \\ ( ( {α}_{i , j - 1}^{n} + {α}_{i , j}^{n} ) ( {u}_{i , j}^{n} - {u}_{i , j - 1}^{n} ) ) + \\ {β}_{i , j}^{n} ( {f}_{i , j}^{n} - {u}_{i , j}^{n} ) \\ where {u}_{- 1 , j}^{n} = {u}_{0 , j}^{n} , {u}_{M + 1 , j}^{n} = {u}_{M , j}^{n} \\ {u}_{i , - 1}^{n} = {u}_{i , 0}^{n} , {u}_{i , N + 1}^{n} = {u}_{i , N}^{n}\end{matrix} \qquad ( 24 )$$

A joint HDR was performed with noise reduction PDE.

$$\frac{\partial u}{\partial t} = div ( α ∇ u ) + β ( f - u ) , f - {8.29 [ ln ( u + 1 ) ]}^{2} \\ α = {e}^{\frac{{‖ ∇ u ‖}^{2}}{{k}^{2}}} , β = const \qquad ( 25 )$$

The above PDE is applied to the luminance component.

It should be noted that alternatives may be utilized for the expressions ƒ and α, insofar as ƒ and α vary in space and time and depend on the signal itself or on some other parameter, such as seen in FIG. 4 in which ƒ and α for the RED channel depend on the intensity of the GREEN channel.

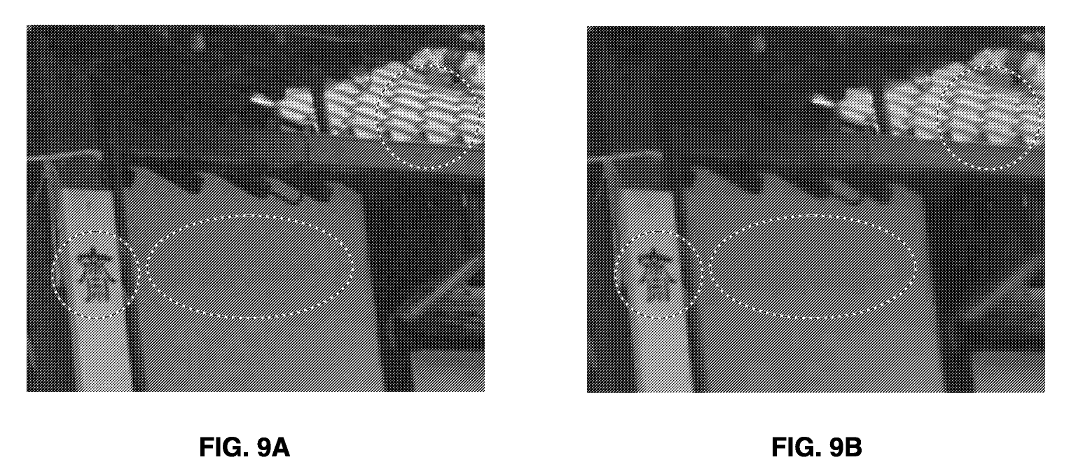

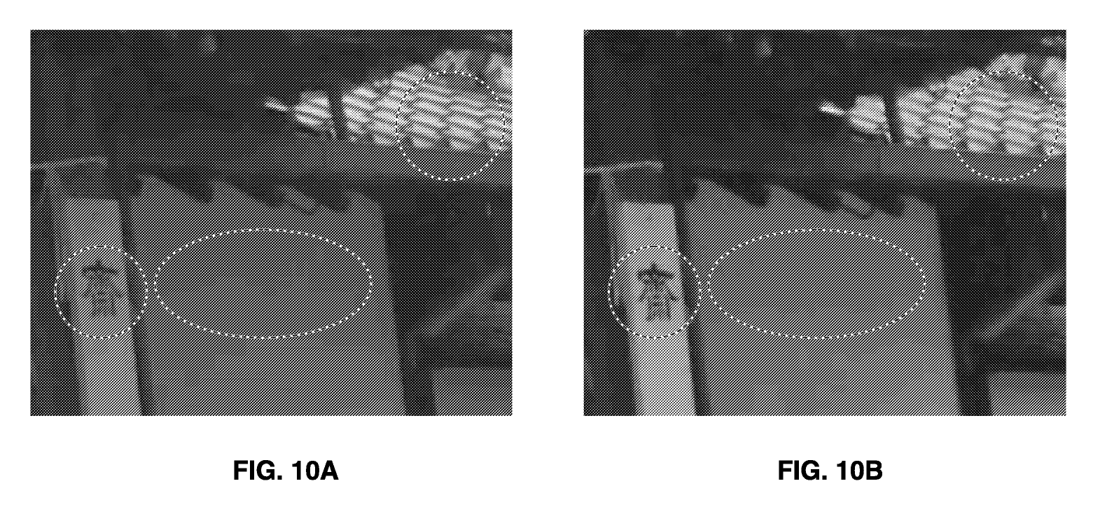

FIG. 9A-9B and FIG. 10A-10B compare high dynamic range compression techniques. FIG. 9A depicts the current best practices HDR compression. It will be noted from the image segment that the level of noise is high. In FIG. 9B Anisotropic Diffusion Noise Reduction (ADNR) is applied after the current best practices HDR compression which results in visible artifacts and some noise as outlined by the circles. In FIG. 10A-10B the HDR compression and noise reduction (NR) are applied at the same time with PDE. FIG. 10A depicts the use of joint HDR and NR with PDE, wherein the image is well formed with low noise while substantially lacking artifacts. In FIG. 10B an image is shown in which ADNR was applied to current best HDR compression practices, wherein both visible artifacts and noise can be seen in the image. It should be appreciated that the joint consideration of HDR compression and NR with PDE can significantly improve overall performance.

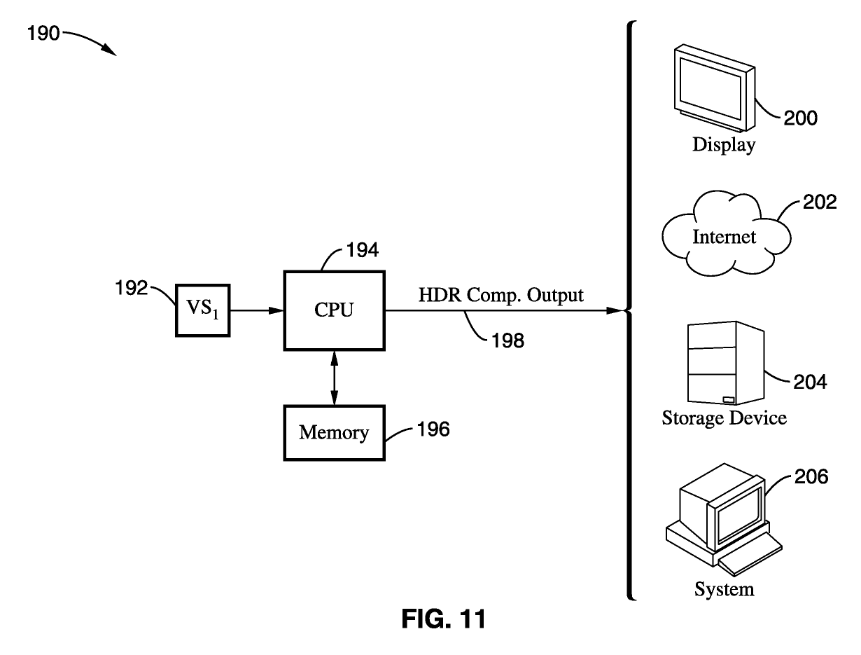

FIG. 11 illustrates an example embodiment 190 of an image processing apparatus configured for performing high dynamic range (HDR) compression, preferably including noise reduction (NR), using a PDE heat equation according to the present invention. Output from an image source 192 (e.g., from an image capture device or from image data storage) is shown received by at least one computer 194 (e.g., CPU, microprocessor, DSP, ASIC containing a processor core, and so forth) which has access to at least one memory 196 from which instructions are executed for performing the method according to the present invention with a HDR compressed output 198.

It should be appreciated that memory 196 can comprise any desired form of memory and combination thereof, into which executable instructions may be received for processing by computer 194, such as internal semiconductor memory (e.g., SRAM, DRAM, FLASH, ROM, and so forth), as well as receiving information from external memory sources including semiconductor memories and media devices. It should be appreciated that the source of the image (video) data may reside on the same device as the programming for performing the inventive method.

The compressed dynamic range output can be utilized in a similar manner as any conventional image output, shown by way of example are a display 200, a communication path 202 (e.g., communicating over a network such as the Internet), stored in a storage device 204 (e.g., for later use), received for use by another system or systems 206, and/or utilized in other ways in a manner similar to that of any conventional image output.

It should be appreciated, that the present invention may be applied to a number of different applications; for example any application in which the dynamic range of images is to be compressed. This includes both with regard to still images and the sequences of images which comprise videos. Hardware and/or programming according to the invention may be operated on general purpose computer systems (e.g., personal computers (PCs), workstations, mainframes, and so forth) and/or within dedicated devices (e.g., still cameras and/or video cameras, image and video output devices, and so forth).

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An apparatus for rendering high dynamic range (HDR) images on low dynamic range (LDR) displays, comprising:
a computer processor configured for receiving an image input;
memory coupled to said computer processor;
programming, retained in said memory, executable on said computer processor for,
representing HDR image pixel intensity as a function of several independent variables,
describing the changes of image pixel intensity with a partial differential equation (PDE) in response to said function and its partial derivatives with respect to said independent variables, and
obtaining LDR image pixel intensity as a solution of said partial differential equation (PDE).

2. An apparatus as recited in claim 1, wherein said pixel intensity is a channel intensity in a color space.

3. An apparatus as recited in claim 2, wherein said color space is grayscale or selected from the group of color spaces consisting essentially of RGB, YCC, XYZ, La*b*, HLS.

4. An apparatus as recited in claim 1, wherein said function depends on pixel location and time.

5. An apparatus as recited in claim 4, wherein rates of external heat transfer for said heat equation vary in space and time.

6. An apparatus as recited in claim 1, wherein said function depends on channel, pixel location and time.

7. An apparatus as recited in claim 1, wherein said solution is obtained by integrating of the partial differential equation (PDE) over time.

8. An apparatus as recited in claim 7, wherein integrating of the PDE over time is performed by using finite differences.

9. An apparatus as recited in claim 1, wherein said partial differential equation (PDE) is the heat equation.

10. An apparatus as recited in claim 9, wherein said heat equation describes heat conduction in non-homogeneous anisotropic media with external heat transfer.

11. An apparatus as recited in claim 1, wherein said heat equation is of the general form
∂T/∂t=b(ƒ(x,y,t,T)−T)+(∂/∂x)(a∂/∂xt)+(∂/∂y)(a∂/∂yT).

12. An apparatus as recited in claim 1, further comprising:
performing noise reduction (NR) in combination with said high dynamic range (HDR) compression;
determining a diffusion coefficient before an iteration of the heat equation; and
adding a diffusion term to the heat equation, or processing NR separately within the same iteration.

13. An apparatus as recited in claim 12, wherein the partial differential equations (PDEs) of said heat equation comprise a mechanism through which the HDR compression and NR processing is combined.

14. An apparatus as recited in claim 13, wherein the multiple equations comprising HDR and NR can be performed within fractional portions of each iteration.

15. An apparatus as recited in claim 12, wherein said method provides higher computational efficiency than performing two separate methods, as the compression and noise reduction are performed during the same iteration pass.

16. An apparatus of performing high dynamic range (HDR) compression and noise reduction (NR) on an image input, comprising:
a computer processor configured for receiving an image input;
memory coupled to said computer processor;
programming, retained in said memory, executable on said computer processor for,
(a) receiving a first image signal,
(b) separating any portions of the color space which are not being processed,
(c) determining external heat source and diffusion coefficient,
(d) establishing boundary conditions for the heat equation,
(e) performing integration of the heat equation on a finite difference grid,
(f) executing additional iterations of steps (c) though (e) until a desired stop condition is reached, and
(g) combining any separated portions of the color space to generate an image output.

17. An apparatus as recited in claim 16, wherein said color space is grayscale or selected from the group of color spaces consisting essentially of RGB, YCC, XYZ, La*b*, HLS.

18. An apparatus as recited in claim 16, wherein said heat equation is of the general form
∂T/∂t=b(ƒ(x,y,t,T)−T)+(∂/∂x)(a∂/∂xt)+(∂/∂y)(a∂/∂yT).

19. A method for rendering high dynamic range (HDR) images on low dynamic range (LDR) displays, comprising:
representing HDR image pixel intensity as a function of several independent variables;
describing the changes of image pixel intensity with a partial differential equation (PDE) in response to said function and its partial derivatives with respect to said independent variables; and
obtaining LDR image pixel intensity as a solution of said partial differential equation (PDE).

20. A computer-readable media containing a computer program executable on a computer configured for high dynamic range (HDR) compression and noise reduction (NR) in response to steps, comprising:
determining an external heat source and diffusion coefficient,
performing HDR compression and NR within the same iteration of partial differential for a heat equation, and
performing iterations of the above through space and time to arrive at an image output.
